(19) United States
(12) Patent Application Publication
(10) Pub. No.: US 2019/0234302 A1
(43) Pub. Date: Aug. 1, 2019

(54) DIFFUSION FLAME BURNER FOR A GAS TURBINE ENGINE

(71) Applicant: Siemens Energy, Inc., Orlando, FL (US)

(72) Inventors: Gurdev Singh, Orlando, FL (US); Charles A. Carlson, Jr., Chuluota, FL (US); Heena H. Dandwani, Orlando, FL (US); Khalil Farid Abou-Jaoude, Winter Springs, FL (US); George Joseph Robinson, Oviedo, FL (US); Selvam Veerappan, Orlando, FL (US)

(21) Appl. No.: 16/381,111

(22) Filed: Apr. 11, 2019

Related U.S. Application Data
(63) Continuation of application No. 14/470,014, filed on Aug. 27, 2014.

(51) Int. Cl. F02C 3/22; F02C 3/30; F23R 3/36

(52) U.S. Cl. CPC F02C 3/22; F23R 3/36; F02C 3/30

(57) ABSTRACT

A gas turbine engine operable using either one of a first fuel and a second fuel includes a water supply and a diffusion flame burner including an innermost spray cone, a plurality of spray cones positioned around the innermost spray cone and grouped into a plurality of stages, and a plurality of outlets positioned around the innermost spray cone. A plurality of valves is arranged to connect the first fuel, the second fuel, and the water supply to the diffusion flame burner and a controller is operable to configure the plurality of valves at least in part in response to which of the first fuel and the second fuel is being consumed. When consuming the first fuel, the valves are configured to deliver a mixture of the first fuel and a quantity of water to the plurality of outlets, and to deliver a quantity of water to the plurality of spray cones, and to selectively activate one or more of the stages to allow passage through only the spray cones of the activated stages.

### FIELD OF THE INVENTION

The invention relates to gas turbine engines, and more particularly to a diffusion flame burner for a gas turbine engine.

### BACKGROUND OF THE INVENTION

FIG. 1 illustrates a conventional diffusion flame burner 10 that is positioned within a combustor 11 chamber of a gas turbine engine (not shown). When operating in a gas mode, a premixture of primary water and natural gas are injected through the primary injector outlets 34 and secondary water is injected through the central nozzle 30. The secondary water is injected, to reduce a combustion temperature of the premixed primary water and natural gas within the combustor 11 chamber. During the gas mode, the injected premixture of natural gas and water is ignited in the combustor 11 and is used to power the gas turbine engine.

When operating in an oil mode, oil is injected from the central nozzle 30 into the combustor 11 and air or water is injected into the combustor 11 through atomizing holes 12 that are positioned around the central nozzle 30. During a startup of the oil mode (i.e. low load) of the gas turbine engine, oil is injected from the central nozzle 30 at a low flow rate, and air is injected from the atomizing holes 12 at a sufficient flow rate and at a sufficient injection pressure, in an effort to atomize the injected oil. For example, during the startup mode at low injection pressure, the injected oil from the central nozzle 30 may not be sufficiently atomized for ignition in the combustor 11 and the injected air from the atomizing holes 12 is used to help atomize the oil. Subsequently during engine loading after startup, the oil is injected from the central nozzle 30 at a high flow rate, and water is injected from the atomizing holes 12 at a sufficient flow rate and a sufficient injection pressure, to atomize the injected oil.

### SUMMARY OF THE INVENTION

In one construction, a gas turbine engine operable using either one of a first fuel and a second fuel includes a water supply and a diffusion flame burner including an innermost spray cone, a plurality of spray cones positioned around the innermost spray cone and grouped into a plurality of stages, and a plurality of outlets positioned around the innermost spray cone. A plurality of valves is arranged to connect the first fuel, the second fuel, and the water supply to the diffusion flame burner and a controller is operable to configure the plurality of valves at least in part in response to which of the first fuel and the second fuel is being consumed. When consuming the first fuel, the valves are configured to deliver a mixture of the first fuel and a quantity of water to the plurality of outlets, and to deliver a quantity of water to the plurality of spray cones, and to selectively activate one or more of the stages to allow passage through only the spray cones of the activated stages.

In another construction, a gas turbine engine operable using either one of a first fuel and a second fuel includes a water supply and a diffusion flame burner including an innermost spray cone, a plurality of spray cones positioned around the innermost spray cone and grouped into a first quantity of stages, and a plurality of outlets positioned around the innermost spray cone. The engine also includes a first quantity of water flow paths, each one of the water flow paths positioned to connect the water supply to one and only one of the stages of the first quantity of stages and a first quantity of fuel flow paths, each one of the fuel flow paths positioned to direct the second fuel to one and only one of the stages of the first quantity of stages. The engine also includes a first quantity of water valves, each one of the water valves positioned in one and only one water flow path and a first quantity of fuel valves, each one of the fuel valves positioned in one and only one fuel flow path. A controller operates when the gas turbine is consuming the first fuel to close each of the fuel valves and to selectively open one or more of the water valves, and when the gas turbine is consuming the second fuel to close each of the water valves and to selectively open one or more of the fuel valves.

In yet another construction, a gas turbine engine operable using either one of a first fuel and a second fuel includes a water supply, a sensor operable to measure a turbine parameter, and a diffusion flame burner including, an innermost spray cone, a plurality of spray cones positioned around the innermost spray cone and grouped into a first quantity of stages, and a plurality of outlets positioned around the innermost spray cone. A controller operates to determine which of the first fuel and the second fuel is being consumed by the gas turbine engine. The controller directs one of the first fuel and a mixture of the first fuel and water to the outlets and selectively activates one or more of the first quantity of stages at least partially in response to the measured turbine parameter to deliver water through the activated spray cones when the first fuel is being consumed, and selectively directs water to the innermost spray cone and selectively activates one or more of the first quantity of stages at least partially in response to the measured turbine parameter to deliver the second fuel through the activated spray cones when the second fuel is being consumed.

### BRIEF DESCRIPTION OF THE DRAWINGS

The invention is explained in the following description in view of the drawings that show:

FIG. 1 is a cross-sectional end view of a prior art diffusion flame burner used in a gas turbine engine;

FIG. 2 is a schematic diagram of a gas turbine engine including a diffusion flame burner according to the present invention; and

FIG. 3 is a cross-sectional end view of a diffusion flame burner used in the gas turbine engine of FIG. 2.

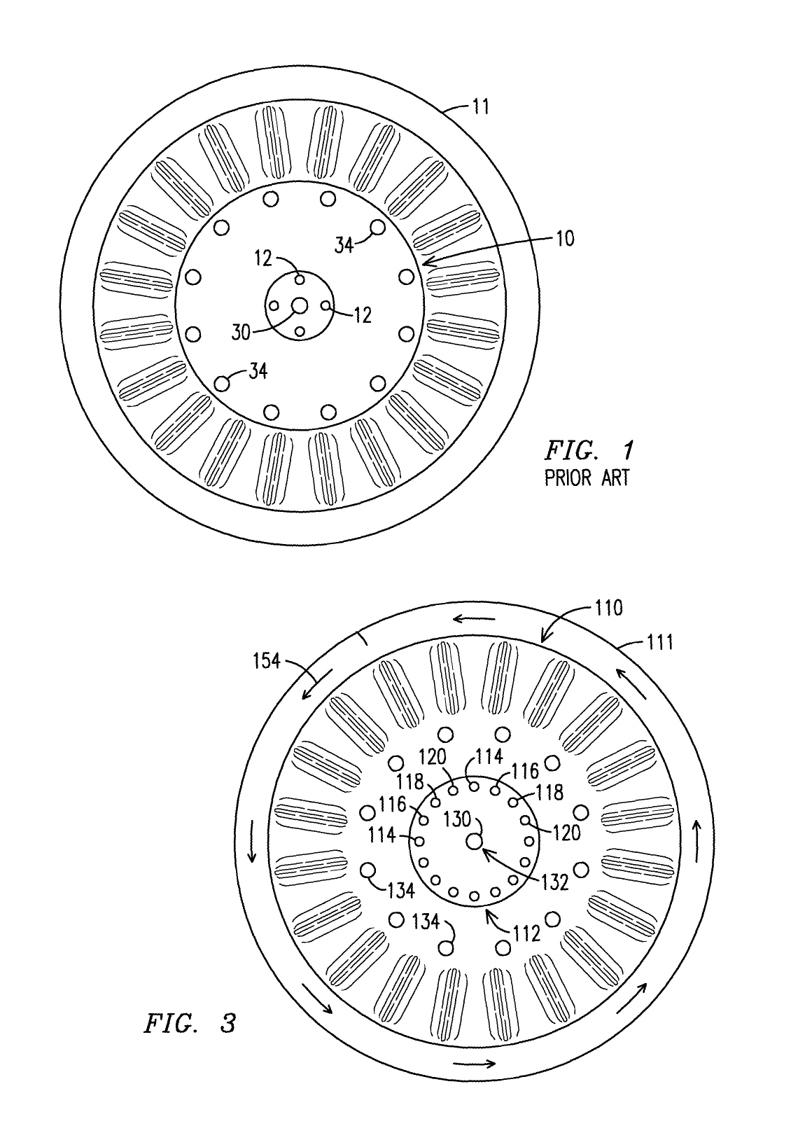

### DETAILED DESCRIPTION OF THE INVENTION

The present inventors have recognized several limitations of the conventional diffusion flame burner used to inject oil and atomizing water into the combustor during an oil mode operation of the gas turbine engine or to inject a premixture of natural gas and water and atomizing water into the combustor during a gas mode operation of the gas turbine engine. As appreciated by one skilled in the art, the level of NOx (Oxides of Nitrogen) is proportional to a combustion temperature within the combustor 11, and is subject to rigorous industrial standards. When operating in the oil mode, in addition to atomizing the oil injected from the central nozzle 30, the injected water from the atomizing holes 12 reduces the local flame zone temperature within the combustor 11, and thus advantageously reduces the production of NOx within the combustor 11. However, the present inventors recognized various adverse effects of the injected water from the atomizing holes 12, including that the injected water follows a jet-like stream which escapes the flame area, strikes the inner surface of the combustor 11, resulting in undesired water cold spot damage to the inner surface of the combustor 11. Additionally, the present inventors recognized that the injection pressure of the water from the atomizing holes 12 is not optimal for the atomization of the oil at all power levels. Specifically, at low power levels, the flow rate of water is low and the injection pressure of water is low from the atomizing holes 12, which may be insufficient to atomize the injected oil from the oil nozzle 30.

Thus, the present inventors have developed an improved diffusion flame burner operating in the oil mode, which injects the atomizing water into the combustor with a swirl cone-like spray, as opposed to the jet-like stream of the conventional diffusion flame burner, thereby increasing the tendency of spray water to self-atomize early and hence reducing the impact of the atomizing water with the inner surface of the combustor 11. The hollow cone-like spray diffuses the water over a wider area, thereby enhancing the atomization of the oil with the injected water. Additionally, since the cone-like spray spreads the water out over a wider area, the impact of the spray (i.e., force per unit area) with the inner surface of the combustor is reduced. Such spray nozzles that form cone-like sprays are available, such as Swirl type nozzle provided by Parker Hannifin Company, for example.

Additionally, when operating in the gas mode, the improved diffusion flame burner provides water injection through staged nozzles, thereby ensuring an optimal injection pressure of the water, over a wide range of injection parameters of the premixture of natural gas and water. For example, the improved diffusion flame burner provides water injection through the circumferentially staged nozzles at the optimal injection pressure, over a wide range of flow rates of gas to the primary outlets, thereby ensuring atomization of the injected secondary stage water over the wide range of gas flow rates. This improves water and gas mixing which ultimately improves NOx.

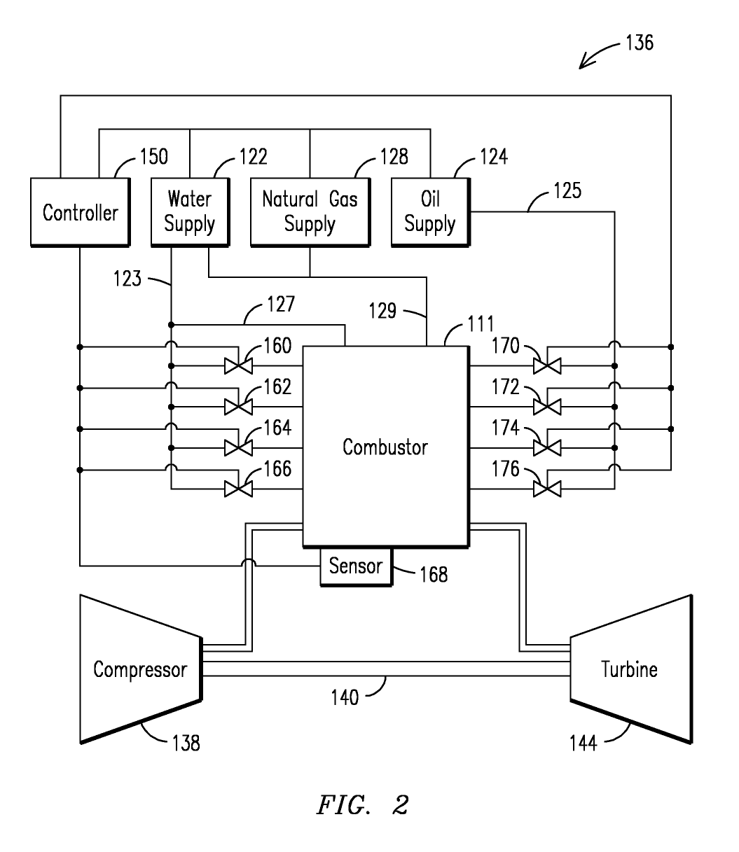

FIG. 2 illustrates a gas turbine engine 136 including a compressor 138 which generates compressed air that is received by a combustor 111, where the compressed air is mixed with injected fuel from a diffusion flame burner 110 (FIG. 3) and ignited. The resulting combusted gas is received by a turbine 144 to perform work, such as rotating a shaft 140 of the gas turbine engine 136. As further illustrated in FIG. 2, a water supply 122, an oil supply 124 and a natural gas supply 128 are provided with the gas turbine engine 136.

During the gas mode operation of the gas turbine engine 136, a water line 123 supplies water from the water supply 122 through one or more stage valves 160, 162, 164, 166 and to the diffusion flame burner 110 within the combustor 111. A controller 150 is connected to the stage valves 160, 162, 164, 166, and selectively opens one or more of the stage valves 160, 162, 164, 166, so that the water supplied from the water supply 122 passes through the one or more opened stage valves and to the diffusion flame burner 110. Additionally, a combined water and natural gas line 129 supplies a combination of water from the water supply 122 and natural gas from the natural gas supply 128 to the diffusion flame burner 110 within the combustor 111.

During an oil mode operation of the gas turbine engine 136, water lines 123, 127 supplies water from the water supply 122 to the diffusion flame burner 110 within the combustor 111. Additionally, during the oil mode, an oil line 125 supplies oil from the oil supply 124 through one or more stage valves 170, 172, 174, 176 and to the diffusion flame burner 110 within the combustor 111. The controller 150 is connected to the control valves 170, 172, 174, 176, and selectively opens one or more of the stage valves 170, 172, 174, 176, so that oil supplied from the oil supply 124 passes through the one or more opened stage valves and to the diffusion flame burner 110. As illustrated in FIG. 2, the controller 150 is coupled to the stage valves 160, 162, 164, 166, the stage valves 170, 172, 174, 176, the water supply 122, the oil supply 124, the natural gas supply 128 and the diffusion flame burner 110 within the combustor 111, in order to perform various control functions during the gas mode operation or the oil mode operation of the diffusion flame burner 110, as discussed in greater detail below.

FIG. 3 illustrates the diffusion flame burner 110 that is positioned within the combustor 111 of the gas turbine engine 136 depicted in FIG. 2. As illustrated in FIG. 3, the diffusion flame burner 110 includes concentrically oriented spray cones 112 that are staged in stages 114, 116, 118, 120, which are respectively connected to the stage valves 160, 162, 164, 166 when the gas turbine engine 136 is operating in the gas mode and are respectively connected to the stage valves 170, 172, 174, 176 when the gas turbine engine 136 is operating in the oil mode.

During the gas mode operation of the gas turbine engine 136, the outlets 134 of the diffusion flame burner 110 are attached to the water supply 122 and the natural gas supply 128 along the combined water and gas line 129 of FIG. 2. During a startup of the gas mode, the outlets 134 inject natural gas within the interior of the combustor 111 and ignite. Once a threshold load is reached, water from the water supply 122 is ejected through selectively activated stages 114, 116, 118, 120 of the spray cones 112, based on the selectively opened stage valves 160, 162, 164, 166 by the controller 150. Also at the same threshold load, a pre-determined fraction of water from the water supply 122 is injected through the outlets 134. In an exemplary embodiment, the threshold load is in a range of 30-40% of the full load, such as approximately 35% of the full load, for example. The controller 150 determines which stage valves 160, 162, 164, 166 to open, based on the load of the gas turbine engine 136 or a flow rate of the natural gas along the gas line 129. For example, at a low load (i.e. the threshold load) and low flow rate of the natural gas, the controller 150 may open the stage valve 160, and thus water supplied from the water supply 122 is only ejected through the stage 114 of the spray cones 112 at an optimal injection pressure and a low flow rate. In another example, at a full load and high flow rate of the natural gas, the controller 150 may open the stage valves 160, 162, 164, 166 and thus water supplied from the water supply 122 is ejected through all stages 114, 116, 118, 120 of the spray cones 112 at an optimal injection pressure and a high flow rate. Thus, the flow rate of water through the spray cones 112 can be varied while still maintaining the optimal injection pressure, by the controller 150 selectively activating more or less stages 114, 116, 118, 120, based on the current load of the gas turbine engine 136. The injection pressure of water through the activated stages is an optimal injection pressure, and is based on an upstream pressure of water in the water line 123 upstream of the stage valves 160, 162, 164, 166. The staging of secondary water injection into the combustor 111 reduces the local flame zone temperature in a combustor basket over a wide range of flow rates of the natural gas. The spray cones 112 inject water in a cone-shape to within the interior of the combustor 111. In an exemplary embodiment, the spray angle of the injected water from the spray cones 112 may be in a range of 75-110 degrees, for example, and the spray angle may be based on a diameter of the spray cone 112 nozzles and an upstream pressure of water within the water line 123, for example. Additionally, as illustrated in FIG. 3, the spray cones 112 in each stage 114, 116, 118, 120 have a circumferential uniform arrangement in the diffusion flame burner 110. Although the spray cones 112 of the diffusion flame burner 110 feature sixteen spray cones that are arranged in four stages, this arrangement is merely exemplary and the spray cones may be arranged in any number of spray cones and stages, provided that the stages are arranged to be activated based on the parameters discussed below. Although the spray cones 112 depicted in FIG. 3 are arranged in a concentric circular arrangement, the spray cones of the present invention need not be arranged in this specific arrangement, provided that the spray cones are staged and positioned to inject water at the optimal injection pressure to atomize the water within the combustor 111 and/or reduce a combustion temperature within the combustor 111 over a wide range of flow rates, as discussed below.

During the oil mode operation of the gas turbine engine 136, the central spray cone 130 positioned at the center 132 of the spray cones 112 is attached to the water supply 122 along the water lines 123, 127 of FIG. 2. During a startup of the oil mode, oil from the oil supply 124 is ejected in a cone-shape through selectively activated stages 114, 116, 118, 120 of the spray cones 112 at an optimal injection pressure, based on the selectively opened stage valves 170, 172, 174, 176 by the controller 150. The controller 150 determines which stage valves 170, 172, 174, 176 to open, based on the load of the gas turbine engine 136 or a flow rate of the oil along the oil line 125. For example, at a low load and low flow rate of oil, the controller 150 may open the stage valve 170, and thus oil supplied from the oil supply 124 is only ejected in a cone-shape through the stage 114 of the spray cones 112 at a low flow rate and at the optimal injection pressure. In an exemplary embodiment, the oil ejected from the stage 114 at low load is self-atomizing, based on a reduced diameter of the spray cones 112 in the stage 114, relative to the diameter of the spray cones 112 in the other stages 116, 118, 120, for example. In another example, at a full load and high flow rate of oil, the controller 150 may open the stage valves 170, 172, 174, 176 and thus oil supplied from the oil supply 124 is ejected in a swirled hollow cone-shape through all stages 114, 116, 118, 120 of the spray cones 112 at a high flow rate and at the optimal injection pressure. Thus, the flow rate of oil through the spray cones 112 can be varied while still maintaining the optimal injection pressure, by the controller 150 selectively activating more or less stages 114, 116, 118, 120, based on the current load of the gas turbine engine 136. The injection pressure of oil through the activated stages is an optimal injection pressure, and is based on an upstream pressure of oil in the oil line 125 upstream of the stage valves 170, 172, 174, 176. During the startup, once a threshold load is reached, water from the water supply 122 is ejected in a cone-shape through the central spray cone 130, to atomize the injected oil from the activated stages and/or to reduce the combustion temperature within the combustor 111. In an exemplary embodiment, the threshold load is in a range of 30-40% of the full load, such as approximately 35% of the full load, for example.

Although FIG. 3 depicts that the central spray cone 130 is positioned at the center 132 of the spray cones 112, the spray cone 130 need not be positioned at the center of the spray cones 112 and may be positioned anywhere within an interior of the spray cones 112. Additionally, the diffusion flame burner 110 need not feature the central spray cone 130, provided that an alternate diffusion outlet is provided to inject water into the combustor 111 during the oil mode of the gas turbine engine 136.

During the gas mode operation, the outlets 134 inject the water/natural gas premixture and the spray cones 112 inject the water at a sufficient flow rate and at the optimal injection pressure, to atomize the natural gas and to reduce the combustion temperature of the water/natural gas premixture within the combustor 111. To inject the water at the sufficient flow rate, the controller 150 opens a sufficient number of the stage valves 160, 162, 164, 166 so that a sufficient number of stages 114, 116, 118, 120 of the spray cones 112 are activated, resulting in a sufficient flow rate of water through the spray cones 112. During the gas mode, the injected water through the number of activated stages of the spray cones 112 is injected at the optimal injection pressure, to reduce the combustion temperature of the water/natural gas premixture within the combustor 111.

If the controller 150 determines that the gas turbine engine 136 is to operate in the gas mode, the controller 150 selectively activates one or more stages 114, 116, 118, 120 of the spray cones 112 by selectively opening one or more of the stage valves 160, 162, 164, 166, along with the other control steps for the gas mode discussed herein. If the controller 150 determines that the gas turbine engine 136 is to operate in the oil mode, the controller selectively activates the one or more stages 114, 116, 118, 120 of the spray cones by selectively opening one or more of the stage valves 170, 172, 174, 176 along with the other control steps for the oil mode discussed herein. The input sensor 168 may be a flow rate sensor to measure a flow rate of the oil through the oil line 125, a pressure sensor to measure a pressure of an air flow 154 (FIG. 3) within the combustor 111, or a flow rate sensor to measure a relative flow rate between the air flow 154 in the combustor 111 and the oil supplied along the oil line 125. The controller 150 may also selectively activate one or more stages 114, 116, 118, 120 of the spray cones 112 based on other input parameters related to operation of the diffusion flame burner 110, such as a viscosity of the oil supplied along the oil line 125, a heat content of the oil supplied along the oil line 125 or a power level of the gas turbine engine, for example.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

What is claimed is:

1. A gas turbine engine operable using either one of a first fuel and a second fuel, the gas turbine engine comprising:
a water supply;
a diffusion flame burner including an innermost spray cone, a plurality of spray cones positioned around the innermost spray cone and grouped into a plurality of stages, and a plurality of outlets positioned around the innermost spray cone;
a plurality of valves arranged to connect the first fuel, the second fuel, and the water supply to the diffusion flame burner; and
a controller operable to configure the plurality of valves at least in part in response to which of the first fuel and the second fuel is being consumed, wherein when consuming the first fuel, the valves are configured to deliver a mixture of the first fuel and a quantity of water to the plurality of outlets, and to deliver a quantity of water to the plurality of spray cones, and wherein the controller selectively activates one or more of the stages to allow passage through only the spray cones of the activated stages.

2. The gas turbine engine of claim 1, wherein when consuming the second fuel, the controller configures the plurality of valves to selectively deliver water to the innermost spray cone, and to deliver the second fuel to the plurality of spray cones, and wherein the controller selectively activates one or more of the stages to allow passage through only the spray cones of the activated stages.

3. The gas turbine engine of claim 2, wherein the controller measures a gas turbine load, and wherein the controller delivers water to the innermost spray cone in response to the turbine load exceeding a non-zero predetermined level.

4. The gas turbine engine of claim 1, further comprising a sensor positioned to measure a turbine parameter and to deliver a measured turbine parameter to the controller, and wherein the controller determines which stages to activate at least in part in response to the measured turbine parameter.

5. The gas turbine engine of claim 4, wherein the turbine parameter is one of a flow rate of one of the first fuel and the second fuel, an air flow pressure, and a gas turbine load.

6. The gas turbine engine of claim 1, wherein each of the spray cones discharges water in a swirling hollow cone-shaped pattern having a small diameter near the spray cone and expanding as a distance from the spray cone increases.

7. The gas turbine engine of claim 6, wherein a spray angle of one of the spray cones is between 75-110 degrees.

8. The gas turbine engine of claim 1, wherein the plurality of stages includes a first quantity of stages, and wherein a first quantity of water flow paths is arranged such that each water flow path extends from the water supply to the spray cones of one and only one stage of spray cones, and wherein the plurality of valves includes a first quantity of water valves, each water valve positioned in one of the water flow paths and movable between a closed position to prevent the flow of water to the associated stage and open to allow the flow of water to the associated stage.

9. The gas turbine engine of claim 1, wherein the first fuel is natural gas and the second fuel is oil.

10. A gas turbine engine operable using either one of a first fuel and a second fuel, the gas turbine engine comprising:
a water supply;
a diffusion flame burner including an innermost spray cone, a plurality of spray cones positioned around the innermost spray cone and grouped into a first quantity of stages, and a plurality of outlets positioned around the innermost spray cone;
a first quantity of water flow paths, each one of the water flow paths positioned to connect the water supply to one and only one of the stages of the first quantity of stages;
a first quantity of fuel flow paths, each one of the fuel flow paths positioned to direct the second fuel to one and only one of the stages of the first quantity of stages;
a first quantity of water valves, each one of the water valves positioned in one and only one water flow path;
a first quantity of fuel valves, each one of the fuel valves positioned in one and only one fuel flow path; and
a controller operable when the gas turbine is consuming the first fuel to close each of the fuel valves and to selectively open one or more of the water valves, and when the gas turbine is consuming the second fuel to close each of the water valves and to selectively open one or more of the fuel valves.

11. The gas turbine engine of claim 10, wherein the controller selectively directs one of a flow of the first fuel and a mixture of the first fuel and water to the outlets at least partially in response to a first parameter when the gas turbine engine is consuming the first fuel, and selectively directs water to the innermost spray cone at least partially in response to the first parameter when the gas turbine engine is consuming the second fuel.

12. The gas turbine engine of claim 11, wherein the first parameter is a gas turbine load.

13. The gas turbine engine of claim 10, further comprising a sensor positioned to measure a turbine parameter and to deliver a measured turbine parameter to the controller, and wherein the controller determines which of the water valves and fuel valves to open at least partially in response to the measured turbine parameter.

14. The gas turbine engine of claim 13, wherein the turbine parameter is one of a flow rate of one of the first fuel and the second fuel, an air flow pressure, and a gas turbine load.

15. The gas turbine engine of claim 10, wherein each of the spray cones discharges water in a swirling hollow cone-shaped pattern having a small diameter near the spray cone and expanding as a distance from the spray cone increases.

16. The gas turbine engine of claim 10, wherein the first fuel is natural gas and the second fuel is oil.

17. A gas turbine engine operable using either one of a first fuel and a second fuel, the gas turbine engine comprising:
a water supply;
a sensor operable to measure a turbine parameter;
a diffusion flame burner including:
an innermost spray cone;
a plurality of spray cones positioned around the innermost spray cone and grouped into a first quantity of stages; and
a plurality of outlets positioned around the innermost spray cone; and
a controller operable to determine which of the first fuel and the second fuel is being consumed by the gas turbine engine, the controller operable to direct one of the first fuel and a mixture of the first fuel and water to the outlets and to selectively activate one or more of the first quantity of stages at least partially in response to the measured turbine parameter to deliver water through the activated spray cones when the first fuel is being consumed, and to selectively direct water to the innermost spray cone and to selectively activate one or more of the first quantity of stages at least partially in response to the measured turbine parameter to deliver the second fuel through the activated spray cones when the second fuel is being consumed.

18. The gas turbine engine of claim 17, wherein the turbine parameter is one of a flow rate of one of the first fuel and the second fuel, an air flow pressure, and a gas turbine load.

19. The gas turbine engine of claim 17, wherein each of the spray cones discharges water in a swirling hollow cone-shaped pattern having a small diameter near the spray cone and expanding as a distance from the spray cone increases.

20. The gas turbine engine of claim 17, wherein the controller measures a turbine load and in response to the turbine load exceeding a non-zero predetermined level directs the mixture of the first fuel and water to the outlets when consuming the first fuel and directs water to the innermost spray cone when consuming the second fuel.

21. The gas turbine engine of claim 17, wherein the first fuel is natural gas and the second fuel is oil.
